(19) United States
(12) Patent Application Publication
(10) Pub. No.: US 2010/0248697 A1
(43) Pub. Date: Sep. 30, 2010

(54) Apparatus, Method and Computer Program Product Providing Signaling of Blocking, Pilot Measurements and Neighbor Cell List For Facilitating Adaptive Interference Coordination

(75) Inventors: Klaus I. Pedersen, Aalborg (DK); Preben E. Morgensen, Gistrup (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/518,247

(22) PCT Filed: Dec. 10, 2007
(86) PCT No.: PCT/IB07/03840

§ 371 Date: May 3, 2010

(30) Foreign Application Priority Data
Dec. 11, 2006 (US) 60874324

(51) Int. Cl. H04M 3/42

(52) U.S. Cl. 455/414.1

(57) ABSTRACT

In accordance with an exemplary embodiment of the invention there is a method that includes.receiving a network device originated signaling, where the signaling comprises an indication of an occurrence of a call blocking event, and using the received signaling to make an adaptive interference control algorithm (AIC) decision, where the AIC decision results in at least a modification of a transmitted power pattern of the own device or one other network device for reducing inter-cell interference.

### TECHNICAL FIELD

The exemplary and non-limiting embodiments of this invention relate generally to wireless communication systems, methods, devices and computer program products and, more specifically, relate to techniques related to interference coordination and avoidance.

### BACKGROUND

The following abbreviations are herewith defined:

3GPP third generation partnership project

UTRAN universal terrestrial radio access network

Node B base station

UE user equipment

E-UTRAN evolved UTRAN

eNB EUTRAN Node B

LTE long term evolution

PS packet scheduling

SC-FDMA single carrier, frequency division multiple access

UL uplink (UE to eNB)

DL downlink (eNB to UE)

AC admission control

IC interference control

RRM radio resource management

SFR soft frequency reuse

CQI channel quality indicator

QoS quality of service

A proposed communication system known as evolved UTRAN (E-UTRAN, also referred to as UTRAN-LTE or as E-UTRA) is currently under discussion within the 3GPP. The current working assumption is that the DL access technique will be OFDM, and the UL access technique will be SC-FDMA.

One of the proposed IC schemes for UTRAN-LTE employs SFR, where different parts of the frequency band are transmitted with different power levels.

Previous proposals presented in 3GPP for signaling to support adaptive IC schemes have mainly focused on raw physical layer measurements, such as the exchange of UE channel CQI measurements, or pilot measurements, between cells. However, these previous proposals do not address the problem from a RRM and QoS point of view.

For example, and as is stated in 3GPP TR 25.814, V7.0.0 (2006-06), 3rd Generation Partnership Project; Technical Specification Group Radio Access Network; Physical layer aspects for evolved Universal Terrestrial Radio Access (UTRA) (Release 7), in Section 7.2.1.6, “Inter-cell interference mitigation”, three approaches to inter-cell interference mitigation are currently being considered: inter-cell interference randomization, inter-cell interference cancellation, and inter-cell interference coordination and avoidance.

In addition, the use of beam-forming antenna solutions at the base station is a general method that can also be seen as a means for downlink inter-cell-interference mitigation. The different approaches could, at least to some extent, complement each other, i.e., they are not necessarily mutually exclusive.

The possibility to perform inter-cell interference cancellation at the UE is considered irrespective of the interference mitigation scheme adopted at the transmitter. The radio interface definition should facilitate the acquisition of channel parameters of a limited number of (strongest) interfering cells (e.g. through orthogonal reference signals).

Section 7.1.2.6.1 deals with inter-cell-interference randomization, while section 7.1.2.6.2 deals with inter-cell-interference cancellation. In this latter section a discussion is made of intra-cell signaling, where a UE needs to be signaled whether it can perform a cancellation to the received ICI, and inter-cell signaling, where interfering signal configurations (e.g., interleaver pattern ID, modulation scheme, FEC scheme and coding rate) are also be signaled to the UE.

In section 7.1.2.6.3, “inter-cell-interference co-ordination/avoidance”, it is said that the common theme of inter-cell-interference co-ordination/avoidance is to apply restrictions to the downlink resource management (configuration for the common channels and scheduling for the non-common channels) in a coordinated way between cells. These restrictions can be in the form of restrictions to what time/frequency resources are available to the resource manager or restrictions on the transmit power that can be applied to certain time/frequency resources. Such restrictions in a cell will provide the possibility for improvement in SIR, and cell-edge data-rates/coverage, on the corresponding time/frequency resources in a neighbor cell.

It is further said that different assumptions can be made regarding UE measurements/reporting that are needed to support downlink interference co-ordination. In a first alternative no additional UE measurement and reporting is needed, in addition to the CQI reports that are needed in any case to support channel-dependent scheduling and link adaptation. In a second alternative additional UE measurement and reporting of average path loss (including shadowing) to current and neighbor cells. In a third alternative, and in addition to the measurements/reports of the second alternative, additional measurement and reporting is made of the average interference for the frequency reuse sets.

It is further stated that inter-cell interference co-ordination will require certain inter-communication between different network nodes in order to set and reconfigure the above mentioned scheduler restrictions. Two cases are considered: static interference co-ordination, where reconfiguration of the restrictions is done on a time scale corresponding to days, and the inter-node communication is very limited (basically with a rate of in the order of days); and semi-static interference co-ordination, where reconfiguration of the restrictions is performed on a time scale corresponding to seconds or longer.

The inter-node communication is said to correspond to information needed to decide on reconfiguration of the scheduler restrictions. Examples of communicated information are given as traffic-distribution within the different cells, and the downlink interference contribution from cell A to cell B. The inter-node communication is also said to apply as well to the actual reconfiguration decisions.

### SUMMARY OF THE EXEMPLARY EMBODIMENTS OF THE INVENTION

In a first aspect thereof the exemplary embodiments of this invention provide a method comprising receiving a network device originated signaling, where the signaling comprises an indication of an occurrence of a call blocking event, and using the received signaling to make an adaptive interference control algorithm (AIC) decision, where the AIC decision results in at least a modification of a transmitted power pattern for reducing inter-cell interference.

In another aspect of the exemplary embodiments of the invention there is a computer readable medium encoded with a computer program executable by a processor to perform actions comprising receiving a network device originated signaling, where the signaling comprises an indication of an occurrence of a call blocking event, and using the received signaling to make an adaptive interference control algorithm (AIC) decision, where the AIC decision results in at least a modification of a transmitted power pattern for reducing inter-cell interference.

In still another aspect of an exemplary embodiment of the invention there is an apparatus comprising a receiver, the receiver coupled to an adaptive interference control algorithm (AIC) block configured to receive a network device originated signaling, where the signaling comprises an indication of an occurrence of a call blocking event, and the AIC block configured to use the received signaling to make an adaptive interference control algorithm (AIC) decision, where the AIC decision results in at least a modification of a transmitted power pattern for reducing inter-cell interference.

In another aspect of an exemplary embodiment of the invention there is an integrated circuit comprising a first circuit to receive a network device originated signaling, where the signaling comprises an indication of an occurrence of a call blocking event, and a second circuit to use the received signaling to make an adaptive interference control algorithm (AIC) decision, where the AIC decision results in at least a modification of a transmitted power pattern for reducing inter-cell interference.

In yet another aspect of an exemplary embodiment of the invention there is an apparatus comprising means for receiving a network device originated signaling, where the signaling comprises an indication of an occurrence of a call blocking event, and means for using the received signaling to make an adaptive interference control algorithm (AIC) decision, where the AIC decision results in at least a modification of a transmitted power pattern for reducing inter-cell interference.

In another aspect of an exemplary according to the invention there is a method comprising detecting at a network device an occurrence of a call blocking event, and originating signaling from the network device to at least one other network device, where the signaling comprises an indication of the occurrence of the call blocking event.

In still another aspect of an exemplary embodiment of the invention there is a computer readable medium encoded with a computer program executable by a processor to perform actions comprising detecting at a network device an occurrence of a call blocking event, and originating signaling from the network device to at least one other network device, where the signaling comprises an indication of the occurrence of the call blocking event.

### BRIEF DESCRIPTION OF THE DRAWINGS

In the attached Drawing Figures:

FIG. 1 shows a simplified block diagram of various electronic devices that are suitable for use in practicing the exemplary embodiments of this invention; and

FIGS. 2, 3, 4, 5, and 6 are each a logic flow diagram descriptive of a method, and the operation of execution of a computer program product, in accordance with the exemplary embodiments of this invention.

### DETAILED DESCRIPTION

By way of introduction, the exemplary embodiments of this invention relate to signaling and measurement support between network elements to facilitate IC for 3GPP LTE, although the use of the exemplary embodiments is not limited to only this one particular type of wireless communication system. More specifically, there is provided a set of cell specific measurements from eNBs to support IC, including adaptive IC.

It can be determined through simulations that an optimal power pattern for SFR depends at least on the traffic distribution. To achieve a maximum benefit from using SFR, the power pattern should be capable of being adaptively updated as a function of at least traffic variations in the network. The exemplary embodiments of this invention provide a technique for signaling and sharing measurement results between network elements to facilitate the realization of adaptive IC.

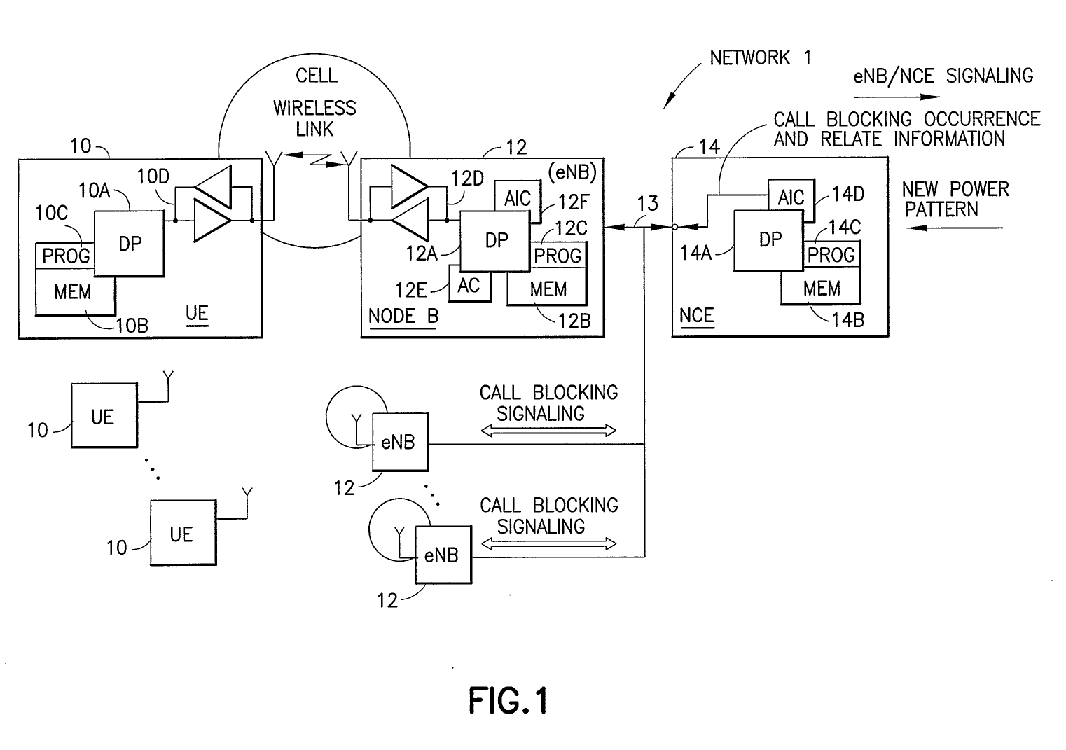

Reference is made first to FIG. 1 for illustrating a simplified block diagram of various electronic devices that are suitable for use in practicing the exemplary embodiments of this invention. In FIG. 1 a wireless network 1 is adapted for communication with a LTE 10 via a Node B (base station, also referred to herein as an eNB) 12. The network 1 may include a network control element (NCE) 14. The UE 10 includes a data processor (DP) 10A, a memory (MEM) 10B that stores a program (PROG) 10C, and a suitable radio frequency (RF) transceiver 10D for bidirectional wireless communications with the Node B 12, which also includes a DP 12A, a MEM 12B that stores a PROG 12C, and a suitable RF transceiver 12D. The Node B 12 is coupled via a data path 13 to the NCE 14 that also includes a DP 14A and a MEM 14B storing an associated PROG 14C. At least one of the PROGs 12C and 14C is assumed to include program instructions that, when executed by the associated DP, enable the electronic device to operate in accordance with the exemplary embodiments of this invention, as will be discussed below in greater detail.

That is, the exemplary embodiments of this invention may be implemented at least in part by computer software executable by the DP 12A of the Node B (eNB) 12, and/or by the DP 14A of the NCE 14, or by hardware, or by a combination of software and hardware.

In a typical case there will be a plurality of UEs 10, and a plurality of eNBs 12 each supporting a cell within which the UEs 10 can be found. Depending on the locations of the eNBs 12 some of the cells will be adjacent and/or overlapping, and thus can be considered as neighboring cells.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

Discussing now in further detail the exemplary embodiments of this invention, the LTE architecture may include a cell-specific AC in each eNB 12 (shown as the AC function 12E in FIG. 1). The AC function 12E grants admission to new calls, assuming that the new call can be served with the required QoS, while still being capable of serving the other users in the cell with their guaranteed QoS. Hence, whether a new call is granted admission depends on, as non-limiting examples, the power pattern used in the cell, the interference received from other cells and the amount of traffic in the cell.

If all new calls are granted access by the AC function 12E then there is no urgent need to perform adjustments to the power pattern. However, if the AC function 12E begins to block new calls, then this indicates that at least one potential problem exists that may possibly be solved by performing at least one adjustment to the power pattern. This adjustment can be made within the cell where the call blocking occurs, and/or in neighboring cells in order to reduce the interference into the cell that suffers from call blocking. As a general note that is not to be limiting to the exemplary embodiments of the invention, cells experiencing blocking may be adjusted to have power patterns using higher power levels over a larger bandwidth and neighboring cells may be adjusted to have power patterns with lower power levels within the same bandwidth.

In accordance with the exemplary embodiments of this invention, signaling is performed whenever blocking occurs in a cell so that IC adjustments can be performed to prevent further blocking. As a part of the signaling, the corresponding pilot measurement and neighbor cell list (or pointer to the neighbor cell list) of the UE 10 that was blocked may also be reported. This additional information can be useful when determining if the blocked UE 10 is located close to its serving eNB 12, or on the cell edge (from an interference point of view), as well as cell(s) are likely to cause the inter-cell interference.

The adaptive IC for the E-UTRAN architecture may be implemented with a distributed architecture or with a centralized architecture.

### Distributed Architecture:

With the distributed architecture, the adaptive IC algorithm(s) are located in the eNBs 12 (shown as the block AIC 12F in FIG. 1). In this case whenever blocking of new calls occur in a cell the occurrence of the blocking event, and the corresponding UE 10 pilot measurement and neighbor cell list, are reported to the eNBs of neighboring cells. Given this information, the eNBs 12 of the neighboring cells can chose to modify their power pattern to create less interference, assuming that these cells have sufficient capacity to serve their associated traffic. Similarly, the eNB 12 of the cell where the call blocking event occurs may also perform modifications of its own power pattern to improve the situation.

Note that the rate of IC adaptation (power pattern changes) need not occur each time that a call blocking event occurs. Instead, the IC adaptation may be based on averaged blocking statistics over some predetermined time period (which may be fixed or variable) ranging from, e.g., tens to hundreds to thousands of seconds.

### Centralized Architecture:

With the centralized architecture, the adaptive IC algorithm is located at a centralized network element, shown as the AIC 14D in the NCE 14 of FIG. 1. The NCE 14 may be or may include, as non-limiting examples, an O&M or a RRM server. The NCE 14 is assumed to have communication with different eNBs 12. The occurrence of the blocking event and the corresponding UE 10 pilot measurement information and neighbor cell list is sent from the eNB(s) 12 to the NCE 14 where the AIC 14D algorithm use this information to perform joint power adjustments for a plurality of eNBs 12 (e.g., the affected eNB where the blocking event occurred, and one or more eNBs 12 of neighboring cell(s)). The result of the centralized AIC 14D algorithm (cell specific power pattern) is thus signaled over the link 13 to the eNBs 12. Thus, in accordance with this exemplary embodiment of the invention the AIC 14D uses the blocking occurrence, pilot measurement and neighbor cell information signaled from one or more eNBs 12 to determine a new power pattern that is intended to reduce the occurrence of call blocking in one or more cells. The new power pattern can be determined for some limited sub-set of the eNBs 12, or for all eNBs 12 (network wide).

The exemplary embodiments of this invention thus provide for the signaling of blocking events and related information, such as corresponding UE 10 pilot measurements, between network elements to facilitate the use and implementation of adaptive IC. It should be noted that AIC algorithms/functions 12F/14D may also use other information, such as cell-specific information carried throughout as an input.

As can be appreciated, one non-limiting advantage that can be gained by the use of the exemplary embodiments of this invention is a realization of an effective method for performing adaptive IC, as the adaptation can be based on a simple QoS metric to prevent the occurrence of call blocking.

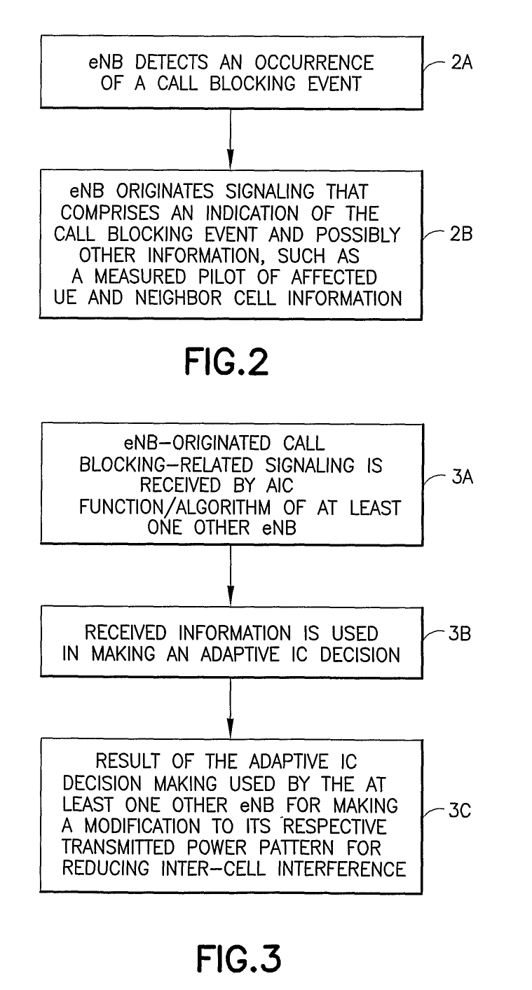

Referring to FIG. 2, and in accordance with a method and a computer program product, at Block 2A an eNB 12 detects an occurrence of a call blocking event (such as with the AC 12E), and at Block 2B the eNB 12 originates signaling that comprises an indication of the call blocking event and possibly other information, such as a measured pilot of the affected UE 10 and information related to neighbor cell(s).

In a first embodiment, and referring to FIG. 3, the eNB-originated call blocking-related signaling is received by the adaptive interference control (AIC) function/algorithm 12F of at least one other eNB 12 (Block 3A) for use in making an adaptive IC decision (Block 3B). In this case a result of the adaptive IC decision making is used by the at least one other eNB 12 for making a modification to its respective transmitted power pattern for reducing inter-cell interference (Block 3C).

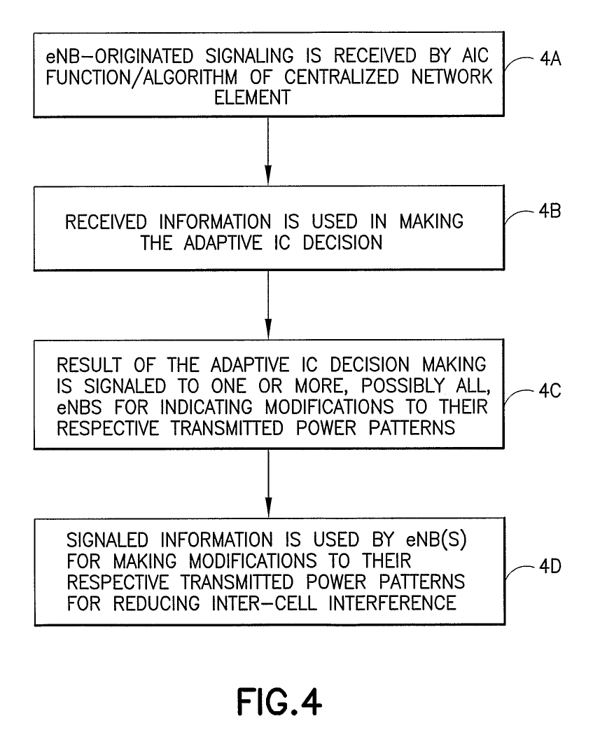

In a second embodiment, and referring to FIG. 4, the eNB-originated signaling is received (Block 4A) by an adaptive interference control (AIC) function/algorithm 14D of a centralized network element, such as the NCE 14, for use in making the adaptive IC decision (Block 4B). In this case a result of the adaptive IC decision making is signaled (Block 4C) to one or more, possibly all, eNBs 12 for indicating modifications to their respective transmitted power patterns for reducing inter-cell interference (Block 4D).

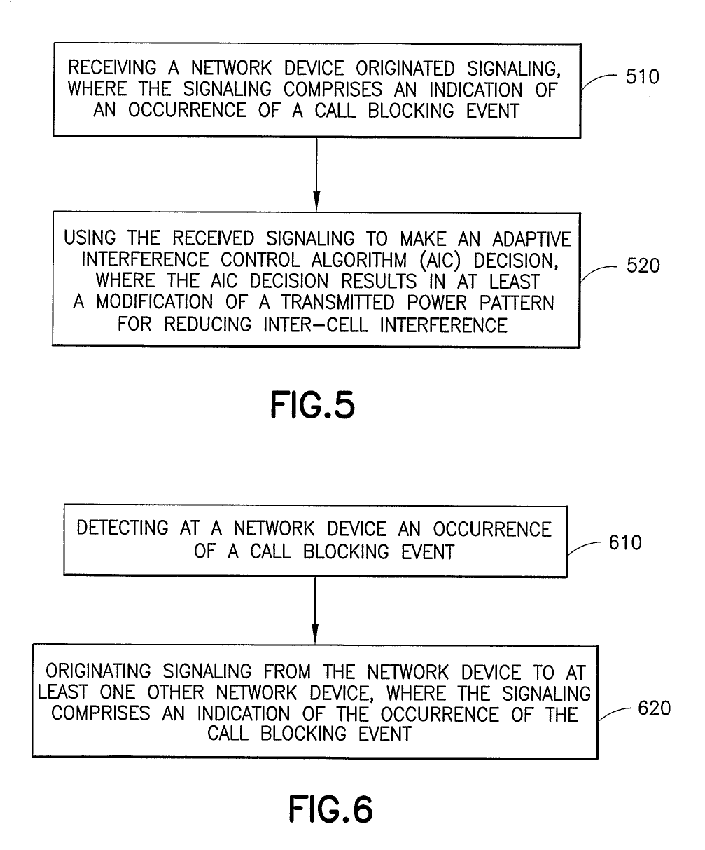

In another non-limiting embodiment of the invention, and referring to FIG. 5, there is described and illustrated at block 510 receiving a network device originated signaling, where the signaling comprises an indication of an occurrence of a call blocking event, and at block 520 using the received signaling to make an adaptive interference control algorithm (AIC) decision, where the AIC decision results in at least a modification of a transmitted power pattern for reducing inter-cell interference.

Further, in yet another non-limiting embodiment, and referring to FIG. 6, there is described and illustrated at block 610 detecting at a network device an occurrence of a call blocking event, and at block 620 originating signaling from the network device to at least one other network device, where the signaling comprises an indication of the occurrence of the call blocking event.

The various blocks shown in FIGS. 2, 3, 4, 5, and 6 may be viewed as method steps, and/or as operations that result from operation of computer program code, and/or as a plurality of coupled logic circuit elements constructed to carry out the associated function(s).

Thus, in a further aspect the exemplary embodiments of this invention provide a distributed adaptive IC system wherein individual eNBs comprise an AC operable to signal an occurrence of a call blocking event, where the signaling comprises an indication of the call blocking event and possibly other information, such as a measured pilot of the affected UE 10 and information related to neighbor cell(s).

In the distributed adaptive IC system of the previous paragraph, where each eNB further comprises an adaptive IC algorithm responsive to signaled call blocking information for making a modification to its respective transmitted power pattern for reducing inter-cell interference.

In a further aspect the exemplary embodiments of this invention provide a centralized adaptive IC system where a network element that is bidirectionally coupled to a plurality of eNBs comprises an adaptive IC algorithm responsive to signaled call blocking information from the eNBs for determining a modification to eNB transmitted powers, and for signaling the determined modification to one or more of the eNBs for reducing inter-cell interference.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems. As such, the reference to eNBs 12 may be generalized to a reference to base stations, such as base transceiver and/or base station control systems and sub-systems. In addition, the NCE 14 may be any network element capable of bidirectional communication with a plurality of base stations for receiving call blocking-related signaling therefrom, and for sending the determined modified transmitted power(s).

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
receiving a network device originated signaling, where the signaling comprises an indication of an occurrence of a call blocking event; and
using the received signaling to make an adaptive interference control algorithm decision, wherein the adaptive interference control algorithm decision results in at least a modification of a transmitted power pattern for reducing inter-cell interference.

2. The method according to claim 1, wherein the network device originated signaling comprises a pilot measurement and neighbor cell related information from a user equipment associated with the call blocking event.

3. The method according to claim 1, wherein the network device originated signaling comprises information for determining location relative to a base station, of a user equipment associated with the call blocking event.

4. The method according to claim 1, wherein the network device originated signaling comprises information of which cell or cells are likely to be a cause of interference.

5. The method according to claim 1, wherein a result of the adaptive interference control algorithm decision is signaled to the at least one other network device to effect a modification of the at least one other network device transmitted power pattern for reducing inter-cell interference.

6. The method according to claim 1, wherein the result of the adaptive interference control algorithm decision is made on a network device and is used to effect a modification of its own transmitted power pattern for reducing inter-cell interference.

7. The method according to claim 1, wherein using the received signaling to make the adaptive interference control algorithm decision is accomplished based at least in part on average blocking statistics over a predetermined time period.

8. The method according to claim 1, where the adaptive interference control algorithm decision is made at least in part using a quality of service metric to prevent an occurrence of call blocking.

9. A computer readable medium encoded with a computer program executable by a processor to perform actions comprising:
receiving a network device originated signaling, where the signaling comprises an indication of an occurrence of a call blocking event; and
using the received signaling to make an adaptive interference control algorithm decision, where the adaptive interference control algorithm decision results in at least a modification of a transmitted power pattern for reducing inter-cell interference.

10-25. (canceled)

26. The apparatus according to claim 10, wherein the network device originated signaling comprises a pilot measurement and neighbor cell related information from a user equipment associated with the call blocking event.

27. The apparatus according to claim 10, wherein the network device originated signaling comprises information for determining location relative to a base station of a user equipment associated with the call blocking event.

28. The apparatus according to claim 10, wherein the network device originated signaling comprises information of which cell or cells are likely to be a cause of interference.

29. The apparatus according to claim 10, wherein a result of the adaptive interference control algorithm decision is signaled to the at least one other network device to effect a modification of the at least one other network device transmitted power pattern for reducing inter-cell interference.

30. The apparatus according to claim 10, wherein the result of the adaptive interference control algorithm decision is made on a network device and is used to effect a modification of its own transmitted power pattern for reducing inter-cell interference.

31. The apparatus according to claim 10, wherein using the received signaling to make the adaptive interference control algorithm decision is accomplished based at least in part on average blocking statistics over a predetermined time period.

32. The apparatus according to claim 10, wherein the adaptive interference control algorithm decision is made at least in part using a quality of service metric to prevent an occurrence of call blocking.

33. The apparatus according to claim 10, wherein the apparatus comprises an integrated circuit.

34. A method, comprising:
detecting at a network device an occurrence of a call blocking event; and
originating signaling from the network device to at least one other network device to result in at least a modification of a transmitted power pattern for reducing inter-cell interference, wherein the signaling comprises an indication of the occurrence of the call blocking event.

35. The method according to claim 19, where the network device originated signaling comprises a pilot measurement and neighbor cell related information from a user equipment that had a call blocking event.

36. The method according to claim 19, wherein the network device originated signaling comprises information for determining whether a user equipment that had a call blocking event is located close to its serving base station, or on a cell edge.

37. The method according to claim 19, wherein the network device originated signaling comprises information of which cell or cells are likely to be a cause of interference.
